(19) United States
(12) Patent Application Publication
(10) Pub. No.: US 2012/0069426 A1
(43) Pub. Date: Mar. 22, 2012

(54) ELECTRONIC PAPER DISPLAY DEVICE AND MANUFACTURING METHOD THEREOF

(75) Inventors: Hwan-Soo LEE, Seoul (KR); Yongsoo OH, Seongnam (KR); Sang Moon LEE, Seoul (KR); Hee Bum LEE, Suwon (KR); Young Woo LEE, Suwon (KR); Sang Jin KIM, Suwon (KR); Hye Yeon CHA, Seongnam (KR); Choong Hee LEE, Suwon (KR)

(73) Assignee: SAMSUNG ELECTRO-MECHANICS CO., LTD.

(21) Appl. No.: 13/234,869

(22) Filed: Sep. 16, 2011

(30) Foreign Application Priority Data
Sep. 17, 2010 (KR) 10-2010-0091690

(51) Int. Cl. G02F 1/167; H01J 9/00

(52) U.S. Cl. 359/296; 445/24

(57) ABSTRACT

There is provided an electronic paper display device and a manufacturing method thereof. The electronic paper display device includes a thin film transistor; a first substrate formed on the thin film transistor and having therein a plurality of pixel electrodes connected to the thin film transistor; a second substrate disposed to face the first substrate and having a common electrode thereon; a plurality of partitions disposed between the first and second substrates to provide a cell space to each of the pixel electrodes; and a display unit disposed in the cell space. The electronic paper display device is superior in the stability and uniformity of an image.

### CROSS-REFERENCE TO RELATED APPLICATIONS

This application claims the priority of Korean Patent Application No. 10-2010-0091690 filed on Sep. 17, 2010, in the Korean Intellectual Property Office, the disclosure of which is incorporated herein by reference.

### BACKGROUND OF THE INVENTION

1. Field of the Invention

The present invention relates to an electronic paper display device and a manufacturing method thereof, and more particularly, to an electronic paper display device that is superior in the stability and uniformity of an image and a manufacturing method thereof.

2. Description of the Related Art

In recent years, changes in the way information is transferred and shared have been required to keep pace with an information society in which a new paradigm is required. In order to satisfy such a requirement, the development of electronic paper capable of being bent as a flexible display has been accelerated, and thus the technological development of electronic paper is now entering a commercially viable stage.

In comparison with an existing flat display panel, electronic paper offers lower manufacturing costs and superior energy efficiency in view of the fact that since electronic paper does not require background lighting or constant recharging, it can be driven even with very little energy. Also, electronic paper is very vivid and has a wide viewing angle. Moreover, electronic paper has a memory function allowing for the retention of characters even without power. These advantages allow for a wide range of electronic paper applications, such as an electronic book having a paper-like appearance and including moving illustrations, a renewable newspaper, a reusable paper display for a mobile phone, a disposable TV screen, or electronic wallpaper. Electronic paper therefore has huge market potential.

Proposed technical methods for the realization of electronic paper are divided into four approaches: a twist ball method allowing for the rotation of spherical particles having oppositely electrically charged upper and lower hemispheres of different colors by using an electric field; an electrophoretic method of keeping charged pigment particles mixed with oil in a microcapsule or a microcup and applying an electric field thereto or allowing charged particles to respond to the application of an electric field; a Quick Response-Liquid Powder Display (QR-LPD) method using a charged liquid powder; or a Cholesteric-Liquid Crystal Display (Ch-LCD) method using the selective reflection of cholesteric liquid crystal molecules.

According to the twist ball method, a cell is filled with a transparent medium, and a twist ball (or a rotatable ball) having opposite electric charges and different colors, for example, a twist ball hemispherically colored black and white is disposed in the transparent medium. When voltage is applied to the twist ball, the twist ball rotates such that the hemisphere having a polarity opposite to that of the applied voltage is positioned toward the front side of a display according to direction of the applied voltage, and thus black or white can be displayed.

### SUMMARY OF THE INVENTION

An aspect of the present invention provides an electronic paper display device that is superior in stability and uniformity of an image and a manufacturing method thereof.

According to an aspect of the present invention, there is provided an electronic paper display device including: a thin film transistor; a first substrate formed on the thin film transistor and having therein a plurality of pixel electrodes connected to the thin film transistor; a second substrate disposed to face the first substrate and having a common electrode thereon; a plurality of partitions disposed between the first and second substrates to provide a cell space to each of the pixel electrodes; and a display unit disposed in the cell space.

The electronic paper display device may further include at least one or more spacers disposed between the second substrate and the partitions.

The electronic paper display device may further include at least one or more spacers disposed between the first substrate and the partitions.

The thin film transistor may include a source electrode, a drain electrode and a gate electrode, and each of the pixel electrodes may be electrically connected to the drain electrode.

The partitions may be integrated with the first substrate.

The partitions may be integrated with the second substrate.

The display unit may be a rotatable ball including two display areas having different colors and different electrical charge properties.

The display unit may be a rotatable ball including first and second display areas having different electrical charge properties. The first display area may be colored any one of red, green and blue and the second display area may be colored black or white.

wherein the display unit is a rotatable ball including first and second display areas having different electrical charge properties,

The display unit may be a rotatable ball including first and second display areas having different electrical charge properties. The first display area may be colored any one of cyan, yellow and magenta and the second display area may be colored black or white.

The display unit may be a microcapsule having transparent fluid including two types of particles sealed therein, the two types of particles being spread in the transparent fluid and having different electrical charge properties.

According to another aspect of the present invention, there is provided a method of manufacturing an electronic paper display device, the method including: forming a first substrate having a plurality of pixel electrodes on a thin film transistor; forming a plurality of partitions on the first substrate so as to provide a cell space to each of the pixel electrodes; placing a display unit in the cell space; and attaching a second substrate having a common electrode to be disposed to face the first substrate and cover the cell space.

The forming of the first substrate may include including a source electrode, a drain electrode and a gate electrode in the thin film transistor, and electrically connecting each of the pixel electrodes to the drain electrode.

The method may further include placing at least one or more spacers on part of the plurality of partitions prior to attaching the second substrate.

The partitions may be integrated with the first substrate.

According to another aspect of the present invention, there is provided a method of manufacturing an electronic paper display device, the method including: forming a first substrate having a plurality of pixel electrodes on a thin film transistor; forming a plurality of partitions on a second substrate having a common electrode to form a plurality of cell spaces; placing a display unit in each of the cell spaces; and attaching the second substrate to the first substrate so as to provide each of the cell spaces formed by the plurality of partitions to each of the pixel electrodes.

The forming of the first substrate may include including a source electrode, a drain electrode and a gate electrode in the thin film transistor, and electrically connecting each of the pixel electrodes to the drain electrode.

The method may further include placing at least one or more spacers on part of the plurality of partitions prior to attaching the second substrate.

The partitions may be integrated with the second substrate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating an electronic paper display device according to an exemplary embodiment of the present invention;

FIG. 2 is a schematic perspective view illustrating an enlarged rotatable ball according to an exemplary embodiment of the present invention;

FIG. 3 schematically illustrates an image on an electronic paper display device according to an exemplary embodiment of the present invention;

FIG. 4 is a schematic cross-sectional view illustrating an electronic paper display device according to another exemplary embodiment of the present invention;

FIGS. 5A through 5C are cross-sectional views illustrating a method of manufacturing an electronic paper display device according to an exemplary embodiment of the present invention; and

FIGS. 6A through 6C are cross-sectional views illustrating a method of manufacturing an electronic paper display device according to another exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like elements.

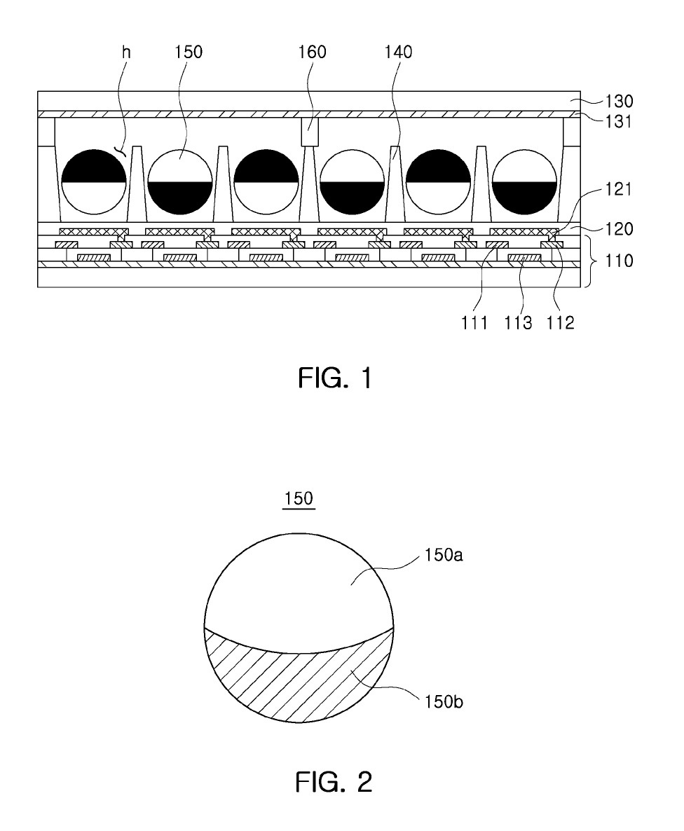

FIG. 1 is a schematic cross-sectional view illustrating an electronic paper display device according to an exemplary embodiment of the present invention. With reference to FIG. 1, an electronic paper display device according to the present embodiment includes a first substrate 120 and a second substrate 130 that are disposed to face each other with a predetermined gap therebetween.

The first substrate 120 is formed on a thin film transistor 110.

The thin film transistor 110 is provided so as to adjust the magnitude and direction of voltage applied to rotatable balls 150, and includes source electrodes 111, drain electrodes 112 and gate electrodes 113.

A plurality of pixel electrodes 21 electrically connected to the respective drain electrodes 112 are formed in the first substrate 120, and a common electrode 131 is formed on the second substrate 130.

A plurality of partitions 140 are formed between the first and second substrates 120 and 130 to provide a single cell space h to each of the pixel electrodes 121. The rotatable balls 150 having electrical and optical anisotropy are disposed as display units in the respective cell spaces h.

The first and second substrates 120 and 130 may be formed of flexible plastic. For example, the plastic may be, but is not limited to, polyethylene terephthalate (PET), polycarbonate (PC), polymethylmethacrylate (PMMA), polyethylenenaphthalate (PEN), Polyethersulfone (PES), cycloolefin copolymer (COC), polydimethylsiloxane (PDMS), poly urethane acrylate (PUA) or the like.

The second substrate 130 may be provided as a display surface and may be formed of a light-transmitting material.

The pixel electrodes 121 and the common electrode 131 may be formed of a conductive material that has been commonly used in this technical field. For example, a conductive polymer such as polythiophene (PT) or polyaniline (PANI), metal particles such as silver or nickel, a polymer film including the metal particles, Indium-Tin-Oxide (ITO), or the like may be used therefor.

A material for the partitions 140 is not particularly limited so long as it has flexibility. A thermosetting resin or a UV-curable resin may be used therefor.

For example, polyethylene terephthalate (PET), polycarbonate (PC), polymethylmethacrylate (PMMA), polyethylenenaphthalate (PEN), Polyethersulfone (PES), cycloolefin copolymer (COC), polydimethylsiloxane (PDMS), or poly urethane acrylate (PUA) may be used therefor.

The partitions 140 may be integrally formed with the first substrate 120.

According to an embodiment of the invention, the first and second substrates 120 and 130 as well as the partitions 140 may be formed of a light-transmitting material in order to improve the brightness of electronic paper. For example, a material having a light-transmitting ratio of 85% or greater may be used therefor; however, the material is not limited thereto.

The rotatable balls 150 having electrical and optical anisotropy are placed as the display units in the cell spaces h, respectively. Also, the cell spaces h are filled with dielectric liquid such that the rotations of the rotatable balls 150 may be facilitated.

FIG. 2 is a schematic perspective view illustrating an enlarged rotatable ball. With reference to FIG. 2, the rotatable balls 150 each have two display areas 150a and 150b having different colors and different electrical charge properties. The two display areas 150a and 150b may be differently colored in such a manner that a first display area 150a may be colored white and a second display area 150b may be colored black. When the first display area 150a is charged with a positive charge, the second display area 150b is charged with a negative charge. When voltage is applied to the rotatable ball 150, the rotatable ball 150 rotates according to the magnitude and direction of the applied voltage, and thus black or white is displayed due to the colors of the two display areas 150a and 150b.

In this case, a method known in the art may be used for processing the rotatable ball 150 electrically and optically to form the first and second display areas 150a and 150b. For example, there may be used a method of applying centrifugal force to a rotatable ball provided to a rotatable disk including two coloring liquids.

The shape of the rotatable ball 150 is not particularly limited. For example, the shape thereof may be a sphere, a prolate spheroid or a cylinder.

Also, the first and second display areas may be colored a variety of colors other than black or white.

For example, the first display area 150a may be colored any one of red (R), green (G) and blue (B), and the second display area 150b may be colored black or white.

Alternatively, the first display area 150a may be colored any one of cyan (C), yellow (Y) and magenta (M), and the second display area 150b may be colored black or white.

Voltage is applied to the rotatable balls 150 through the pixel electrodes 121 and the common electrode 131, and the magnitude and direction of the applied voltage are adjusted by the thin film transistor 110.

The rotatable balls 150 rotate while allowing charged states to be balanced in a parallel manner according to the direction of the applied voltage, and black or white is displayed due to the colors of the two display areas.

Each rotatable ball 150 disposed in each cell space h may be individually driven by the thin film transistor 110, thereby being provided as a pixel area.

According to the present embodiment, the rotatable balls may be disposed in the respective cell spaces formed by the partitions and the rotatable balls may be placed at regular intervals, so that the stability and uniformity of an image may be improved. Also, it is not necessary to use a binder for the fixation of the rotatable balls, so that unnecessary voltage drop and parasitic capacitance may not occur.

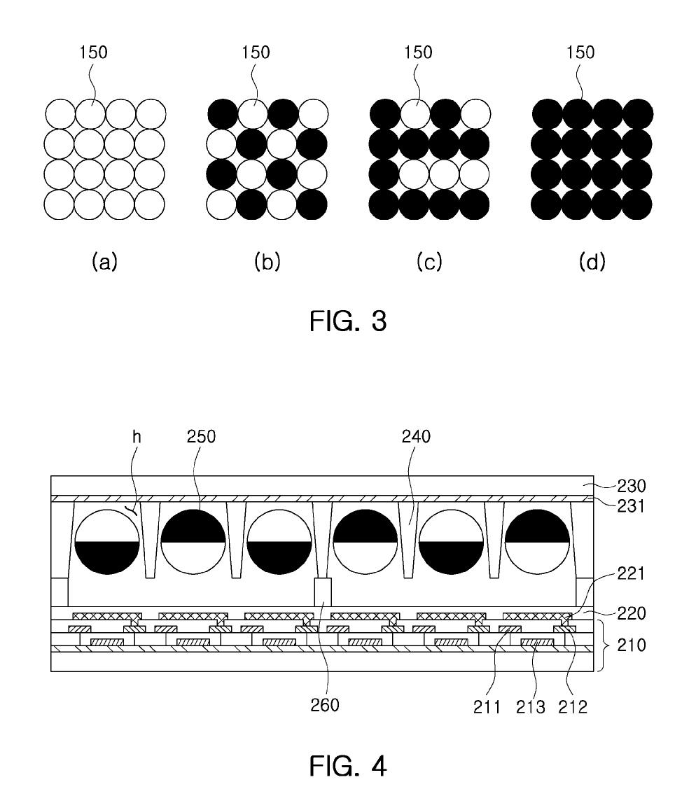

FIG. 3 schematically illustrates an image on an electronic paper display device according to an exemplary embodiment of the present invention.

With reference to FIG. 3, the rotatable balls may be placed at regular intervals and each of them may be individually driven so as to stably display white or black.

Although not shown, a display unit may be a microcapsule having transparent fluid including two types of particles sealed therein, in which the two types of particles are spread in the transparent fluid and have different electrical charge properties.

The microcapsule has the transparent fluid including the two types of particles sealed therein by an outer wall of the microcapsule, in which the two types of particles are spread in the transparent fluid, migrated by an electrophoresis phenomenon and have different electrical charge properties. Those charged particles spread in the transparent fluid may be white particles bearing a positive charge and black particles bearing a negative charge.

When voltage is applied to the microcapsule, the charged particles migrate upward or downward, and black or white is displayed accordingly.

Also, one of the two types of particles may be colored particles having any one of red (R), green (G) and blue (B) colors, and the other thereof may be black or white particles. Alternatively, one of the two types of particles may be colored particles having any one of cyan (C), yellow (Y) and magenta (M) colors, and the other thereof may be black or white particles.

Also, at least one or more spacers 160 may be disposed between the second substrate 130 and the partitions 140. Due to the spacers 160, a predetermined gap may be formed between the second substrate 130 and the rotatable balls 150.

In a case in which light incident on the electronic paper display device acts on the rotatable balls and the partitions, a contrast ratio of the electronic paper display device may be reduced. According to the present embodiment, however, the amount of light acting on the partitions decreases so that the contrast ratio of the electronic paper display device may be improved.

FIG. 4 is a schematic cross-sectional view illustrating an electronic paper display device according to another exemplary embodiment of the present invention. A detailed description of elements different from those in the aforementioned embodiment will be provided below, and a detailed description of the same elements will be omitted.

With reference to FIG. 4, an electronic paper display device according to the present embodiment includes a first substrate 220 and a second substrate 230 that are disposed to face each other with a predetermined gap therebetween.

The first substrate 220 is formed on a thin film transistor 210.

The thin film transistor 210 is provided so as to adjust the magnitude and direction of voltage applied to rotatable balls 250, and includes source electrodes 211, drain electrodes 212 and gate electrodes 213.

A plurality of pixel electrodes 221, electrically connected to the respective drain electrodes 212, are formed in the first substrate 220, and a common electrode 231 is formed on the second substrate 230.

A plurality of partitions 240 are formed between the first and second substrates 220 and 230 to provide a single cell space h to each of the pixel electrodes 221. The rotatable balls 250 having electrical and optical anisotropy are disposed as display units in the respective cell spaces h. The partitions 240 may be integrally formed with the second substrate 230.

Voltage is applied to the rotatable balls 250 through the pixel electrodes 221 and the common electrode 231, and the magnitude and direction of the applied voltage are adjusted by the thin film transistor 210.

The rotatable balls 250 rotate while allowing charged states to be balanced in a parallel manner according to the direction of the applied voltage, and black or white is displayed due to the colors of the two display areas.

As described above, each rotatable ball 250 disposed in each cell space may be individually driven by the thin film transistor 210, thereby being provided as a pixel area.

According to the present embodiment, the rotatable balls are disposed in the respective cell spaces formed by the partitions and the rotatable balls are placed at regular intervals, so that the stability and uniformity of an image may be improved. Also, it is not necessary to use a binder for the fixation of the rotatable balls, so that unnecessary voltage drop and parasitic capacitance may not occur.

Also, in the present embodiment, at least one or more spacers 160 may be disposed between the first substrate 220 and the partitions 240. Due to the spacers 260, a predetermined gap may be formed between the first substrate 220 and the rotatable balls 250.

The gap formed by the spacers 260 may be used as a path for the injection and movement of dielectric liquid filling the cell spaces.

Hereinafter, a method of manufacturing an electronic paper display device according to an exemplary embodiment of the present invention will be described in detail.

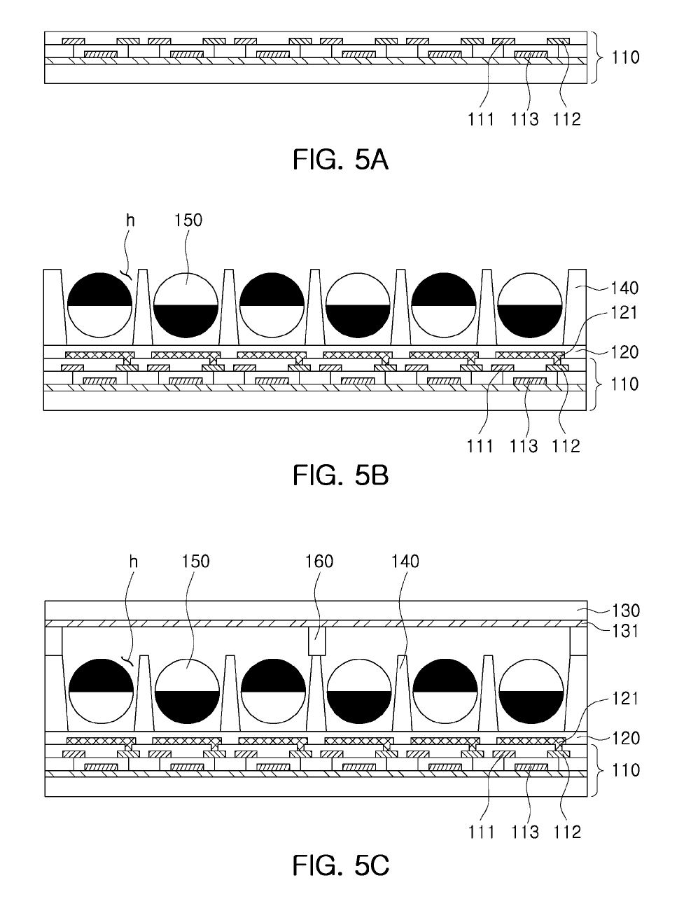

FIGS. 5A through 5C are cross-sectional views illustrating a method of manufacturing an electronic paper display device according to an exemplary embodiment of the present invention.

First of all, as shown in FIG. 5A, the thin film transistor 110 is prepared.

The thin film transistor 110 may have source electrodes 111, the drain electrodes 112 and the gate electrodes 113 formed therein.

Next, as shown in FIG. 5B, the first substrate 120 may be formed on the thin film transistor 110.

The first substrate 120 may be formed of flexible plastic, and may have the plurality of pixel electrodes 121 formed therein. The individual pixel electrodes 121 may be electrically connected to the drain electrodes 112 of the thin film transistor 110.

Then, the plurality of partitions 140 are formed on the first substrate 120 to provide a single cell space h to each of the pixel electrodes 121.

The partitions 140 may be formed of a thermosetting resin or a UV-curable resin. After a resin layer having a predetermined thickness is formed on the first substrate 120, a patterning process may be performed to thereby form the partitions 140.

For example, an imprinting method may be used. More specifically, after a resin layer is formed to have a predetermined thickness, the resin layer is stamped with a stamp having embossed and depressed patterns, thereby forming a plurality of partitions. According to the embossed and depressed patterns of the stamp, the partitions and the cell spaces divided by the partitions are formed. Here, the embossed and depressed patterns of the stamp may be adjusted to thereby adjust the intervals between the partitions and the shapes and sizes of the cell spaces.

Also, the partitions 140 may be integrally formed with the first substrate 120. For example, after a resin layer is prepared to have a predetermined thickness, pixel electrodes are formed in the resin layer. The resin layer is partially removed by a patterning process or the like to thereby form a plurality of partitions.

Thereafter, as shown in FIG. 5C, the rotatable balls 150 are disposed as display units in the plurality of cell spaces h, respectively. The rotatable balls 150 may be disposed within the cell spaces by the use of a mask, a squeegee, or the like. Also, the cell spaces may be filled with dielectric liquid.

Then, the second substrate 130 may be attached to face the first substrate 120 and cover the cell spaces h. At this time, the common electrode 131 may be formed on the second substrate 130.

Also, at least one or more spacers 160 may be disposed on part of the plurality of partitions 140 before attaching the second substrate 130 thereto.

In this manner, the electronic paper display device as shown in FIG. 1 may be manufactured.

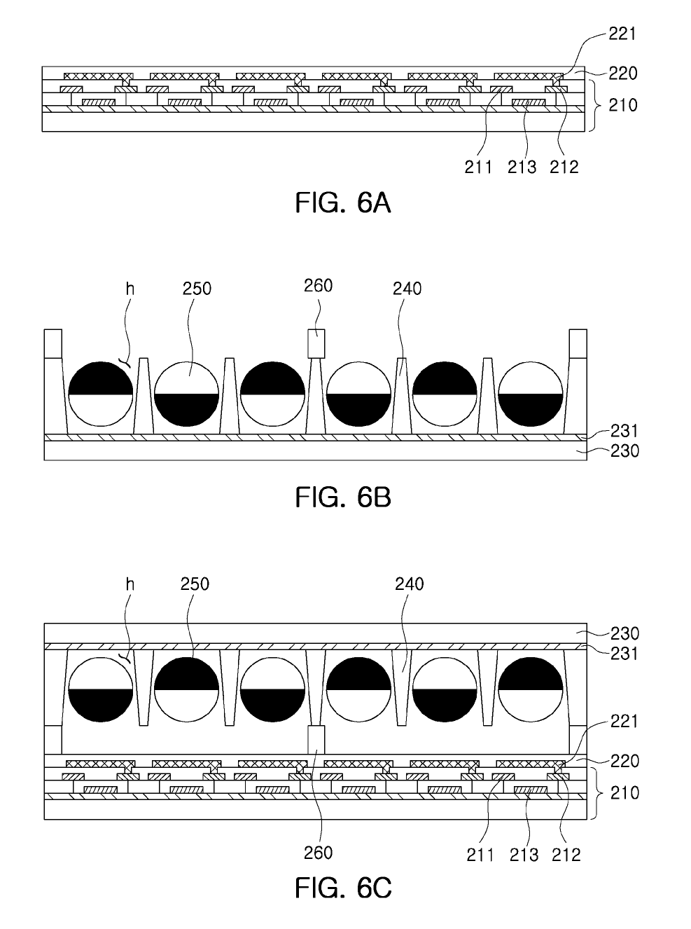

FIGS. 6A through 6C are cross-sectional views illustrating a method of manufacturing an electronic paper display device according to an exemplary embodiment of the present invention.

First of all, as shown in FIG. 6A, the thin film transistor 210 is prepared.

The thin film transistor 210 may have the source electrodes 211, the drain electrodes 212 and the gate electrodes 213 formed therein.

Next, the first substrate 220 may be formed on the thin film transistor 210.

The first substrate 220 may be formed of flexible plastic, and may have the plurality of pixel electrodes 221 formed therein. The individual pixel electrodes 221 may be electrically connected to the drain electrodes 212 of the thin film transistor 210.

Then, as shown in FIG. 6B, the second substrate 230 is prepared. At this time, the common electrode 230 may be formed on the second substrate 230.

Thereafter, the plurality of partitions 240 are formed in the second substrate 230 to divide a space above the second substrate 230 into the plurality of cell spaces h.

The partitions 240 may be formed of a thermosetting resin or a UV-curable resin. After a resin layer having a predetermined thickness is formed on the first substrate 220, a patterning process may be performed to thereby form the partitions 240.

For example, an imprinting method may be used. More specifically, after a resin layer is prepared to have a predetermined thickness, the resin layer is stamped with a stamp having embossed and depressed patterns, thereby forming a plurality of partitions. According to the embossed and depressed patterns of the stamp, the partitions and the cell spaces divided by the partitions are formed. Here, the embossed and depressed patterns of the stamp may be adjusted to thereby adjust the intervals between the partitions and the shapes and sizes of the cell spaces.

Also, the partitions 240 may be integrally formed with the second substrate 230. For example, after a resin layer is prepared to have a predetermined thickness, a common electrode is formed on the resin layer. The resin layer is partially removed by a patterning process or the like to thereby form a plurality of partitions.

Then, the rotatable balls 250 are disposed as display units in the plurality of cell spaces h, respectively. The rotatable balls 250 may be disposed within the cell spaces h by the use of a mask, a squeegee, or the like.

Also, at least one or more spacers 260 may be disposed on part of the plurality of partitions 240.

Then, as shown in FIG. 6C, the first substrate 220 may be attached to face the second substrate 230 and cover the cell spaces h. At this time, the first substrate 220 may be disposed in a manner such that each pixel electrode formed in the first substrate 220 is disposed to correspond to each cell space formed by the partitions 240.

At this time, the outermost spacer 260 may be removed and the cell spaces may be filled with dielectric liquid, and then the removed spacer 260 may be re-attached.

In this manner, the electronic paper display device as shown in FIG. 4 may be manufactured.

In general, the formation of partitions may be exposed to chemical materials during a patterning process. In the case in which the patterning process is performed on a thin film transistor, the thin film transistor may be damaged.

In the present embodiment, however, the formation of the partitions may be performed on the second substrate, and then being attached to the first substrate having the thin film transistor formed thereon. Accordingly, the damage to the thin film transistor may be avoided and the manufacturing process of the electronic paper display device may be facilitated.

As set forth above, according to exemplary embodiments of the invention, a rotatable ball disposed in a cell space may be individually driven by a thin film transistor, thereby being provided as a pixel area.

According to exemplary embodiments of the invention, a rotatable ball is disposed in a cell space formed by partitions and is placed at regular intervals so that the stability and uniformity of an image may be improved. Also, it is not necessary to use a binder for the fixation of the rotatable ball, so that unnecessary voltage drop and parasitic capacitance may not occur.

According to exemplary embodiments of the invention, the amount of light acting on partitions decreases so that a contrast ratio of an electronic paper display device may be improved.

While the present invention has been shown and described in connection with the exemplary embodiments, it will be apparent to those skilled in the art that modifications and variations can be made thereto without departing from the spirit and scope of the invention as defined by the appended claims.

What is claimed is:

1. An electronic paper display device comprising:
a thin film transistor;
a first substrate formed on the thin film transistor and having therein a plurality of pixel electrodes connected to the thin film transistor;
a second substrate disposed to face the first substrate and having a common electrode thereon;
a plurality of partitions disposed between the first and second substrates to provide a cell space to each of the pixel electrodes; and
a display unit disposed in the cell space.

2. The electronic paper display device of claim 1, further comprising at least one or more spacers disposed between the second substrate and the partitions.

3. The electronic paper display device of claim 1, further comprising at least one or more spacers disposed between the first substrate and the partitions.

4. The electronic paper display device of claim 1, wherein the thin film transistor comprises a source electrode, a drain electrode and a gate electrode, and
each of the pixel electrodes is electrically connected to the drain electrode.

5. The electronic paper display device of claim 1, wherein the partitions are integrated with the first substrate.

6. The electronic paper display device of claim 1, wherein the partitions are integrated with the second substrate.

7. The electronic paper display device of claim 1, wherein the display unit is a rotatable ball including two display areas having different colors and different electrical charge properties.

8. The electronic paper display device of claim 1, wherein the display unit is a rotatable ball including first and second display areas having different electrical charge properties,
wherein the first display area is colored any one of red, green and blue and the second display area is colored black or white.

9. The electronic paper display device of claim 1, wherein the display unit is a rotatable ball including first and second display areas having different electrical charge properties,
wherein the first display area is colored any one of cyan, yellow and magenta and the second display area is colored black or white.

10. The electronic paper display device of claim 1, wherein the display unit is a microcapsule having transparent fluid including two types of particles sealed therein, the two types of particles being spread in the transparent fluid and having different electrical charge properties.

11. A method of manufacturing an electronic paper display device, the method comprising:
forming a first substrate having a plurality of pixel electrodes on a thin film transistor;
forming a plurality of partitions on the first substrate so as to provide a cell space to each of the pixel electrodes;
placing a display unit in the cell space; and
attaching a second substrate having a common electrode to be disposed to face the first substrate and cover the cell space.

12. The method of claim 11, wherein the forming of the first substrate comprises including a source electrode, a drain electrode and a gate electrode in the thin film transistor, and electrically connecting each of the pixel electrodes to the drain electrode.

13. The method of claim 11, further comprising placing at least one or more spacers on part of the plurality of partitions prior to attaching the second substrate.

14. The method of claim 11, wherein the partitions are integrated with the first substrate.

15. A method of manufacturing an electronic paper display device, the method comprising:
forming a first substrate having a plurality of pixel electrodes on a thin film transistor;
forming a plurality of partitions on a second substrate having a common electrode to form a plurality of cell spaces;
placing a display unit in each of the cell spaces; and
attaching the second substrate to the first substrate so as to provide each of the cell spaces formed by the plurality of partitions to each of the pixel electrodes.

16. The method of claim 15, wherein the forming of the first substrate comprises including a source electrode, a drain electrode and a gate electrode in the thin film transistor, and electrically connecting each of the pixel electrodes to the drain electrode.

17. The method of claim 15, further comprising placing at least one or more spacers on part of the plurality of partitions prior to attaching the second substrate.

18. The method of claim 15, wherein the partitions are integrated with the second substrate.
